(19) United States
(12) Patent Application Publication
(10) Pub. No.: US 2017/0344099 A1
(43) Pub. Date: Nov. 30, 2017

(54) SYSTEM AND METHOD FOR CONTROLLING POWER CONSUMPTION OF A COMPUTING SYSTEM

(71) Applicants: Inventec (Pudong) Technology Corporation, Shanghai (CN); INVENTEC CORPORATION, Taipei City (TW)

(72) Inventor: Zhong-Ying QU, Shanghai (CN)

(21) Appl. No.: 15/219,884

(22) Filed: Jul. 26, 2016

(30) Foreign Application Priority Data
May 24, 2016 (CN) 201610349302.9

(51) Int. Cl. G06F 1/32; G06F 9/44

(52) U.S. Cl. CPC G06F 1/3287; G06F 9/4401; G06F 1/324; G06F 1/3275

(57) ABSTRACT

A power consumption control technique configures an adjustable range for a frequency of an uncore of a CPU of a computing system so as to determine a power-consumption managing policy for the uncore to be operated at the frequency within the adjustable range, under the situation of independency of frequency-modulating functions individually for the core and the uncore of the CPU of the computing system. The adjustable range for the frequency of the uncore is particularly set by utilizing a BIOS (Basic input/output system) program of the computing system.

### BACKGROUND OF INVENTION

### 1. Field of the Invention

The invention relates to a technique in the computer field, and more particularly to a system and a method for controlling power consumption of a computing system.

### 2. Description of the Prior Art

In general, the server needs to work consistently all year long. Thus, the corresponding power consumption becomes one of crucial issues to both the clients and the manufacturers. It is well known that premier qualities in mechanism design, power management and heat-dissipation arrangement would be beneficial to reduce the power consumption significantly. However, all those aforesaid qualities can only be ensured in the early stage of design, neither in the later stage of design nor in the stage of manufacturing. As long as the development of an electric or electronic product passes the later stage of research or design, a design or manufacturing change in the power management policy for the product is almost infeasible. In the case that a design change in the power management policy is inevitable, the additional cost is usually huge.

Thus, it is definitely welcome to the art by providing a convenient, high-performance but inexpensive power-modulating resort to manage the server so as thereby able to applicable to all stages of the product, especially the later stage of the research and whole stages of manufacturing.

### SUMMARY OF THE INVENTION

Accordingly, it is the primary object of the present invention to provide a system and a method for controlling power consumption of a computing system that can be used to release the current limitation that the server power-consumption managing policy can be altered easily only in the research stage but expensive in the later stages.

In the present invention, the method for controlling power consumption of a computing system includes: under a situation of independency of frequency-modulating functions individually for a core and an uncore of a CPU of the computing system, an adjustable range for the frequency of the uncore being configured so as to determine a power-consumption managing policy for the uncore to be operated at a frequency within the adjustable range; wherein the adjustable range for the frequency of the uncore is set by utilizing a BIOS (Basic input/output system) program of the computing system.

In one embodiment of the present invention, the CPU is one of an Intel Grantly architecture and an Intel Purley architecture.

In one embodiment of the present invention, the uncore includes a CPU cache memory, a QPI (Quick path interconnect) master route controller and an IMC (Integrated memory controller).

In one embodiment of the present invention, the adjustable range for the frequency of the uncore is determined by evaluating the performance, the power consumption and/or the performance per watt of the computing system.

In one embodiment of the present invention, the computing system is applied to a server.

In the present invention, the power-consumption control system for a computing system includes a frequency-modulating module for modulating frequencies for a core and an uncore of a CPU (Central processing unit) of the computing system, and an uncore frequency-modulation setting module for setting an adjustable range for the frequency of the uncore so as further to determine a power-consumption managing policy corresponding to the frequency of the uncore within the adjustable range. The individual frequency-modulating functions for the core and the uncore are independent to each other, and the uncore frequency-modulation setting module is fulfilled through a BIOS (Basic input/output system) program of the computing system.

In one embodiment of the present invention, the CPU is one of an Intel Grantly architecture and an Intel Purley architecture.

In one embodiment of the present invention, the uncore includes a CPU cache memory, a QPI (Quick path interconnect) master route controller and an IMC (Integrated memory controller).

In one embodiment of the present invention, the adjustable range for the frequency of the uncore is determined by evaluating the performance, the power consumption and/or the performance per watt of the computing system.

In one embodiment of the present invention, the computing system is applied to a server.

By providing the present invention, under the situation of independency of the frequency-modulating functions individually for the core and the uncore of the CPU of the computing system, the system and method for controlling power-consumption control of the computing system can configure an adjustable range for the uncore frequency so that the power-consumption managing policy corresponding to the frequency of the uncore within the adjustable range can be provided, in which the adjustable range for the frequency of the uncore is defined by the BIOS program of the computing system. By modulating the frequency for the uncore within the adjustable range, the power-consumption managing policy can be altered quickly and conveniently; and, unlike the conventional design, such a change can be performed at any stage of the development of the electric or electronic product.

All these objects are achieved by the system and the method for controlling power consumption of a computing system described below.

### BRIEF DESCRIPTION OF THE DRAWINGS

The present invention will now be specified with reference to its preferred embodiment illustrated in the drawings, in which:

FIG. 1 demonstrates schematically modules of a CPU architecture of an embodiment of the computing system in accordance with the present invention; and

FIG. 2 demonstrates schematically modules for an embodiment of an embodiment of the power-consumption control system for a computing system in accordance with the present invention.

### DESCRIPTION OF THE PREFERRED EMBODIMENT

The invention disclosed herein is directed to a system and a method for controlling power consumption of a computing system. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

It shall be explained that, in the following embodiments, the accompanying drawings are only provided in a schematic manner so as easily to elucidate the basic concepts of the present invention. Thus, in the drawings, unnecessary details such as practical numbers, shapes and dimensions of elements are overlooked or simplified.

The system and the method of the present invention are applied to a computing system, where the computing system includes a CPU (Central processing unit) and a memory (RAM or ROM). The computing system can be a desktop computer, a notebook computer, a server or any electronic system the like; preferably, a server. The reason that the server is selected as the preferable computing system is because the server is a system that should work in a nonstop manner all year long, and thus the quality of the power-consumption control of the server plays an important role for the performance of the server.

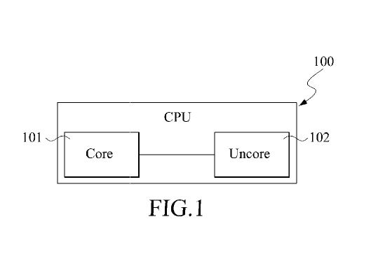

Referring now to FIG. 1, a modular architecture of a CPU 100 of the computing system in accordance with the present invention is schematically shown. The CPU 100 can be an Intel product that has been modularized early from the Nehalem architecture, and include a core 101 and an uncore 102. The core 101 is mainly applied to handle the calculations. The uncore 102 further includes a CPU cache memory, a QPI (Quick path interconnect) master route controller and an IMC (Integrated memory controller).

In the Intel CPU 100, from the early Grantly platform architecture (also called as the Intel Grantly architecture) to the later Purley platform architecture (also called as the Intel Purley architecture, the so-called largest-scale upgrading since the Nehalem architecture), frequency-modulating functions for the core 101 and the uncore 102 are independent to each other. Namely, the frequency of the uncore 102 can be modulated in an independent manner while in cooperating with the frequency of the core 101. Of course, these two frequencies shall be correlated to some extents such that better performance of the CPU 100 can be assured. However, in the instance that low power consumption, but not the performance, is concerned, these two frequencies can be modulated to an unrelated state.

In the present invention, the frequency of the uncore 102 of the CPU 100 is set within an adjustable range, particularly through a BIOS (Basic input/output system) program in the computing system. The BIOS program would provide a functional option UFS (Uncore frequency scaling) for modulating the frequency of the uncore 102. While in configuring the functional options, the adjustable range can be defined by setting an upper bound and a lower bound, so that users can modulate the frequency of the uncore 102 easier only within the adjustable range.

In the present invention, the adjustable range is determined by considering performance, power consumption and/or performance per watt of the computing system. For example, the lower bound of the frequency can be determined by judging acceptable low power consumption but not the performance, while the upper bound thereof is determined by judging only high performance but not the power consumption. Alternatively, the adjustable range can be simply determined according to the performance per watt.

According to the setting of the adjustable range, some experimental results are shown in the following Table 1 through Table 3, in which three types of the Intel CPUs for Table 1 to Table 3, respectively, are evaluation results by a relevant benchmark tool program.

In the tables, through comparisons upon the data detected from different CPUs, by utilizing the UFS option to change the frequency of the uncore from “C1E” to “C1A” for example, it is found that the power consumption decreases. The ssj_ops in the SPEC power stands for the calculated performance of the corresponding CPU. The “Stream” testing result stands for the bandwidth performance of the system memory. The “Target Load” stands for the load applied upon the target system. The “Active Idle” stands for the load-free pressure upon the target system. The “Performance” stands for the performance of the computing system. The “Performance per watt” stands for the ratio of the performance to the power, i.e. the ratio of specific system performance to the corresponding power consumption. The “Average Active Power” stands for the average effective power of the system. The “yes+dd” stands for the pressure-testing result of the pressure-testing tool upon the system performance.

From all these results, it is found that the CPU performance is decreased and the memory performance is also decreased within 1%.

In the case that the UFS of the CPU1 is set to the C1A, the decrease in the power consumption is 10 W, the decrease percentage of the CPU performance is 1.8%, and the decrease percentage of the memory performance is 0.2%.

In the case that the UFS of the CPU2 is set to the C1A, the decrease in the power consumption is 7 W, the decrease percentage of the CPU performance is 4.1%, and the decrease percentage of the memory performance is 0.2%.

In the case that the UFS of the CPU3 is set to the C1A, the decrease in the power consumption is 13 W, the decrease percentage of the CPU performance is 3.3%, and the decrease percentage of the memory performance is 0.2%.

Through the aforesaid testing, the adjustable range of the uncore frequency can be determined at least by evaluating the power consumption, the performance and/or the performance per watt. Thereupon, the power-consumption managing policy for the frequency of the uncore to be operated within the adjustable range can be provided.

TABLE 1
CPU1 Benchmark Results Summary

| | BIOS 90G3T106 Default | | | BIOS 90G3T1206 C1A | | |
|---|---|---|---|---|---|---|
| | | Power | | | Power | |
| | | Average | | | Average | |
| | | Active | | | Active | |
| Target | Performance | Power | Performance | Performance | Power | Performance |
| Load | ssj_ops | (W) | per watt | ssj_ops | (W) | per watt |
| 100% | 1,130,741 | 221 | 5,115 | 1,109,631 | 211 | 5,261 |
| Active Idle | 0 | 113 | 0 | 0 | 114 | 0 |

| | | |
|---|---|---|
| yes + dd | 219.07 | 212.13 |
| Stream | 52551 | 52416 |

TABLE 2
CPU2 UFS Benchmark Results Summary

| | BIOS 90G3T106 Default | | | BIOS 90G3T1206 C1A | | |
|---|---|---|---|---|---|---|
| | | Power | | | Power | |
| | | Average | | | Average | |
| | | Active | | | Active | |
| Target | Performance | Power | Performance | Performance | Power | Performance |
| Load | ssj_ops | (W) | per watt | ssj_ops | (W) | per watt |
| 100% | 830,917 | 176 | 4,713 | 796,154 | 169 | 4,716 |
| Active Idle | 0 | 99.4 | 0 | 0 | 98 | 0 |

| | | |
|---|---|---|
| yes + dd | 171.72 | 166.15 |
| Stream | 52647 | 52503 |

TABLE 3
CPU3 UFS Benchmark Results Summary

| | BIOS 90G3T106 Default | | | BIOS 90G3T1206 C1A | | |
|---|---|---|---|---|---|---|
| | | Power | | | Power | |
| | | Average | | | Average | |
| | | Active | | | Active | |
| Target | Performance | Power | Performance | Performance | Power | Performance |
| Load | ssj_ops | (W) | per watt | ssj_ops | (W) | per watt |
| 100% | 1,308,926 | 249 | 5,251 | 1,265,139 | 236 | 5,371 |
| Active Idle | 0 | 121 | 0 | 0 | 125 | 0 |

| | | |
|---|---|---|
| yes + dd | 241.27 | 231.27 |
| Stream | 59855 | 59696 |

Accordingly, except for the embodiment of the power-consumption control system for a computing system in accordance with the present invention described above, the objects of the present invention can also be fulfilled by a software construction. Preferably, the BIOS program in the computing system is selected mainly to execute the power-consumption control system for a computing system in accordance with the present invention, as described below. Since the following embodiment and the foregoing embodiment are the same in the sense of methodology, thus common details thereabout would be omitted.

In the present invention, the power-consumption control method for a computing system includes:

Under a situation of independency of the frequency-modulating functions individually for a core and an uncore of a CPU of a computing system, an adjustable range for the frequency of the uncore is configured so as to determine the power-consumption managing policy for the uncore to be operated at a frequency within the adjustable range. In the present invention, the adjustable range for the frequency of the uncore is set by utilizing a BIOS program of the computing system.

In one embodiment of the present invention, the CPU is an Intel Grantly architecture or an Intel Purley architecture.

In one embodiment of the present invention, the uncore includes a CPU cache memory, a QPI master route controller and an IMC.

In one embodiment of the present invention, the adjustable range for the frequency of the uncore is determined by evaluating the performance, the power consumption and/or the performance per watt of the computing system.

In one embodiment of the present invention, the computing system is applied to a server.

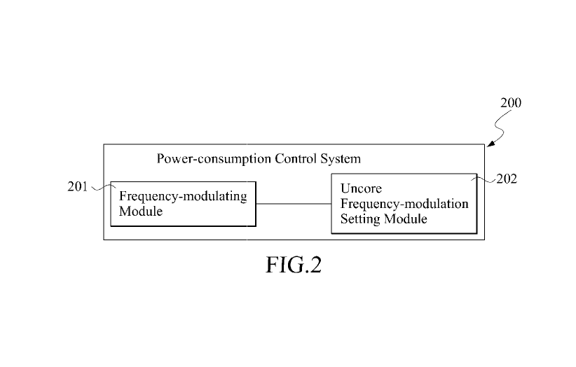

As shown in FIG. 2, the power-consumption control system 200 for a computing system in accordance with the present invention includes a frequency-modulating module 201 and an uncore frequency-modulation setting module 202. The frequency-modulating module 201 is used to modulate the frequencies for the core and the uncore of the CPU of the computing system, in which the individual frequency-modulating functions for the core and the uncore are independent to each other. The uncore frequency-modulation setting module 202 is used to set the adjustable range for the frequency of the uncore so as further to determine the power-consumption managing policy corresponding to the uncore frequencies within the adjustable range. In particular, the uncore frequency-modulation setting module 202 is fulfilled through the BIOS program of the computing system.

In one embodiment of the present invention, the CPU is an Intel Grantly architecture or an Intel Purley architecture.

In one embodiment of the present invention, the uncore includes a CPU cache memory, a QPI master route controller and an IMC.

In one embodiment of the present invention, the adjustable range for the frequency of the uncore is determined by evaluating the performance, the power consumption and/or the performance per watt of the computing system.

In one embodiment of the present invention, the computing system is applied to a server.

In the present invention, frequency modulations upon the core and the uncore can be fulfilled by applying the BIOS program. Namely, the BIOS program can be used directly to adjust the technical schemes of the present invention and particularly to set up purposely the adjustable range for the frequency of the uncore. The aforesaid setting of the present invention can be executed in a software manner, and thus any change in the power management policy for the product is convenient at all stages of the product, which is definitely superior to the conventional design in cost for redesign. Also, such a change can be fulfilled more easily.

In summary, under the situation of independency of the frequency-modulating functions individually for a core and an uncore of a CPU of a computing system, the power-consumption control system and method for the computing system in accordance with the present invention can configure an adjustable range for the uncore frequency so that a power-consumption managing policy corresponding to the frequency of the uncore within the adjustable range can be provided, in which the adjustable range for the frequency of the uncore is defined by the BIOS program of the computing system. By modulating the frequency for the uncore within the adjustable range, the power-consumption managing policy can be altered quickly and conveniently, and, unlike the conventional design, such a change can be performed at any stage of the development of the electric or electronic product.

Definitely, the system and the method provided by the present invention have demonstrated the ability to overcome the shortcomings of the conventional design as described in the background section, and thus the commercial value of the present invention is obvious.

While the present invention has been particularly shown and described with reference to a preferred embodiment, it will be understood by those skilled in the art that various changes in form and detail may be without departing from the spirit and scope of the present invention.

What is claimed is:

1. A power-consumption control method for a computing system, comprising:
under a situation of independency of frequency-modulating functions individually for a core and an uncore of a CPU of the computing system, an adjustable range for the frequency of the uncore being configured so as to determine a power-consumption managing policy for the uncore to be operated at a frequency within the adjustable range;
wherein the adjustable range for the frequency of the uncore is set by utilizing a BIOS (Basic input/output system) program of the computing system.

2. The power-consumption control method of claim 1, wherein the CPU is one of an Intel Grantly architecture and an Intel Purley architecture.

3. The power-consumption control method of claim 1, wherein the uncore includes a CPU cache memory, a QPI (Quick path interconnect) master route controller and an IMC (Integrated memory controller).

4. The power-consumption control method of claim 1, wherein the adjustable range for the frequency of the uncore is determined by evaluating the performance, the power consumption and/or the performance per watt of the computing system.

5. The power-consumption control method of claim 1, wherein the computing system is applied to a server.

6. A power-consumption control system for a computing system, comprising:
a frequency-modulating module, used to modulate frequencies for a core and an uncore of a CPU (Central processing unit) of the computing system, wherein individual frequency-modulating functions for the core and the uncore are independent to each other; and
an uncore frequency-modulation setting module, used to set an adjustable range for the frequency of the uncore so as further to determine a power-consumption managing policy corresponding to the frequency of the uncore within the adjustable range; wherein the uncore frequency-modulation setting module is fulfilled through a BIOS (Basic input/output system) program of the computing system.

7. The power-consumption control system of claim 6, wherein the CPU is one of an Intel Grantly architecture and an Intel Purley architecture.

8. The power-consumption control system of claim 6, wherein the uncore includes a CPU cache memory, a QPI (Quick path interconnect) master route controller and an IMC (Integrated memory controller).

9. The power-consumption control system of claim 6, wherein the adjustable range for the frequency of the uncore is determined by evaluating the performance, the power consumption and/or the performance per watt of the computing system.

10. The power-consumption control system of claim 6, wherein the computing system is applied to a server.
